(19) United States
(12) Patent Application Publication
(10) Pub. No.: US 2007/0261798 A1
(43) Pub. Date: Nov. 15, 2007

(54) Folding device for cordless blind

(76) Inventors: Chih-Shen Hung, Sihu Township (TW); Shin-Min Hung, Sihu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/698,078

(22) Filed: Jan. 26, 2007

(30) Foreign Application Priority Data
May 11, 2006 (TW) 095116646
Dec. 27, 2006 (TW) 095149363

(51) Int. Cl. E06B 9/30

(52) U.S. Cl. 160/170

(57) ABSTRACT

A folding device for a cordless blind includes a string spool and a force-return mechanism. The force-return mechanism includes a transmission shaft coupled to the string spool to turn therewith. A smaller bevel gear is connected to the transmission shaft and meshes with a larger bevel gear rotatable about a vertical axis. A first bobbin is coupled to the larger bevel gear to turn therewith. A spiral spring has two ends respectively engaged with the first bobbin and a second bobbin. Thus, the folding device can be used with a blind having a long shade. The smaller bevel gear presses against the larger bevel gear in a vertical direction and cooperates with the weight of the shade to provide an optional braking effect for the shade in a vertical direction.

### BACKGROUND OF THE INVENTION

1. Field of the Invention

The present invention relates to a folding device for a blind. More particularly, the present invention relates to a folding device for a cordless blind that allows maximum winding in an extremely small space.

2. Description of the Related Art

In addition to shield from the sunlight and to provide privacy, blinds provide decoration and show the user's taste in modern living. A typical blind includes a plurality of slats that can be moved upward or downward by operating a pull cord. However, a child may be strangled by the exposed length of the pull cord.

Taiwan Utility Model No. M289810 proposes a cordless blind to avoid the above-mentioned problem. As illustrated in FIGS. 1 through 3, the cordless blind 1 including an upper beam 11, a fixed seat 12 mounted to an end of the upper beam 11, a cord controller 13 mounted to the other end of the upper beam 11, and a plurality of vertically spaced slats 18. A movable seat 14 is slidably mounted in the upper beam 11 and between the fixed seat 12 and the cord controller 13. A transmission cord 15 is fixed between the movable seat 14 and the cord controller 13. A folding/unfolding cord 16 has an end ex tending through the slats 18 and then fixed to a lower beam 17. The other end of the folding/unfolding cord 16 is wound around a bobbin (not labeled) in the fixed seat 12 and a bobbin (not labeled) in the movable seat 14.

With reference to FIG. 1, when the lower beam 17 is moved downward for unfolding the slats 18, the movable seat 14 is pulled by the folding/unfolding cord 16 to slide through a distance in a direction indicated by the arrow in FIG. 1. The transmission cord 15 on the movable seat 14 drives a rotational seat 131 in the cord controller 13, and torsion springs 132 on two sides of a bottom of the cord controller 13 are wound up and thus store resiliency for returning purposes. On the other hand, with reference to FIG. 2, when the lower beam 17 is moved upward, the transmission cord 15 and the folding/unfolding cord 16 are moved by the returning force from the torsion springs 132, thereby folding the slats 18.

Although such a blind 1 may be operated without a pull cord, several problems still exist. First, the distance between the upper beam 11 and the lower beam 17 ranges from tens of centimeters to two or three meters. The torsion springs 132 must be long enough to assure smooth folding/unfolding of the slats 18. Hence, the length and the volume of the torsion springs 132 are increased, leading to an increase in the overall volume of the cord controller 13. As a result, assembly of the cord controller 13 to the upper beam 11 is inconvenient and troublesome.

Secondly, the winding/unwinding extent of the torsion springs 132 is greatly increased when the distance between the upper beam 11 and the lower beam 17 is large such that the torsion springs 132 are apt to fatigue or even deform or break after a period of time, leading to malfunction of the blind 1.

Thirdly, due to the interrelationship between the transmission cord 15 and the folding/unfolding cord 16, the length of the transmission cord 15 and the length of the folding/unfolding cord 16 must be increased when the distance between the upper beam 11 and the lower beam 17 is large. However, the long folding/unfolding cord 16 must be repeatedly wound between the fixed seat 12 and the movable seat 14, as shown in FIG. 3. This further complicates the assembling procedures of the blind 1 and increases the friction between the folding/unfolding cord 16 and the bobbins. The life of the folding/unfolding cord 16 is shortened and operation of the folding/unfolding cord 16 is adversely affected.

Further, the travel of the movable seat 14 depends on the folding or unfolding travel of the lower beam 17. Hence, the length of the upper beam 11 is decided by the maximum folding travel rather than the actual size of the window to which the blind 1 is mounted. Utility of the blind 1 is thus limited and unsatisfactory.

### SUMMARY OF THE INVENTION

To solve the above-mentioned drawbacks, the present invention provides a folding device for a cordless blind including a string spool and a force-return mechanism. An end of a string extending through a shade of a blind is wound around the string spool. The force-return mechanism includes a transmission shaft coupled to the string spool to turn therewith. A smaller bevel gear is connected to the transmission shaft and meshes with a larger bevel gear rotatable about a vertical axis. A first bobbin is coupled to the larger bevel gear to turn therewith. A spiral spring has two ends respectively engaged with the first bobbin and a second bobbin such that winding movement of the spiral spring about a rotating axis of the first bobbin causes unwinding movement of the spiral spring about a rotating axis of the second bobbin and that unwinding movement of the spiral spring about the rotating axis of the first bobbin causes winding movement of the spiral spring about the rotating axis of the second bobbin. The larger bevel gear and the smaller bevel gear have a gear ratio therebetween to allow high rotating speed of the string spool and low rotating speed of the larger bevel gear such that the string spool is turned with a small winding/unwinding extent of the spiral spring. Thus, the folding device can be used with a blind having a long shade. The smaller bevel gear presses against the larger bevel gear in a vertical direction and cooperates with the weight of the shade to provide an optional braking effect for the shade in a vertical direction.

The rotational shaft may extend through a plurality of spool seats to provide a sufficient force for folding/unfolding a wide blind. Alternatively, the string spools of the respective spool seats can be turned synchronously to allow a lower beam of the blind can be moved upward or downward while maintaining in a horizontal state, avoiding tilt problem of conventional designs.

Preferably, a housing is mounted around the force-return mechanism. The housing includes a base from which two posts extends upward. The first and second bobbins include hollow bodies respectively and rotatably mounted around the posts.

Preferably, a hollow lining sleeve is mounted around at least one of the bodies. The hollow lining sleeve includes a through-hole through which an associated end of the spiral spring extends. The hollow lining sleeve allows sliding movement to provide a buffering effect for the spiral spring when the first or second bobbin turns, avoiding kink of the spiral spring during winding or unwinding.

Preferably, a gear is provided on a top end of the first bobbin and another gear is provided on a top end of the second bobbin and meshed with the gear on the first bobbin. In a preferred form, gears are provided on lower ends of the first and second bobbins and mesh with each other. This assists in precise transmission between the first and second bobbins.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic sectional view illustrating a conventional cordless blind.

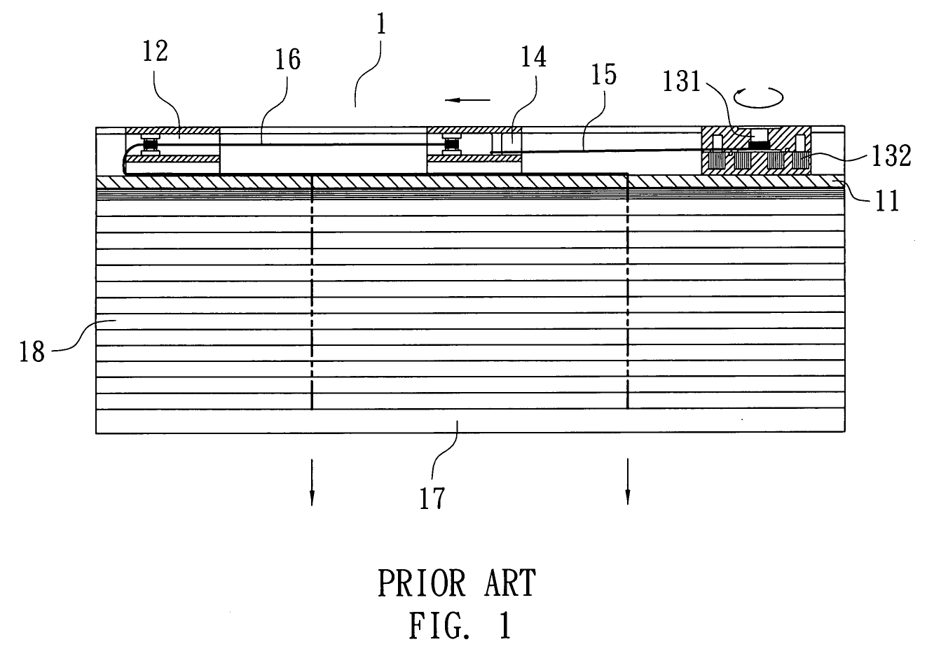

FIG. 2 is a schematic sectional view illustrating folding of slats of the conventional cordless blind.

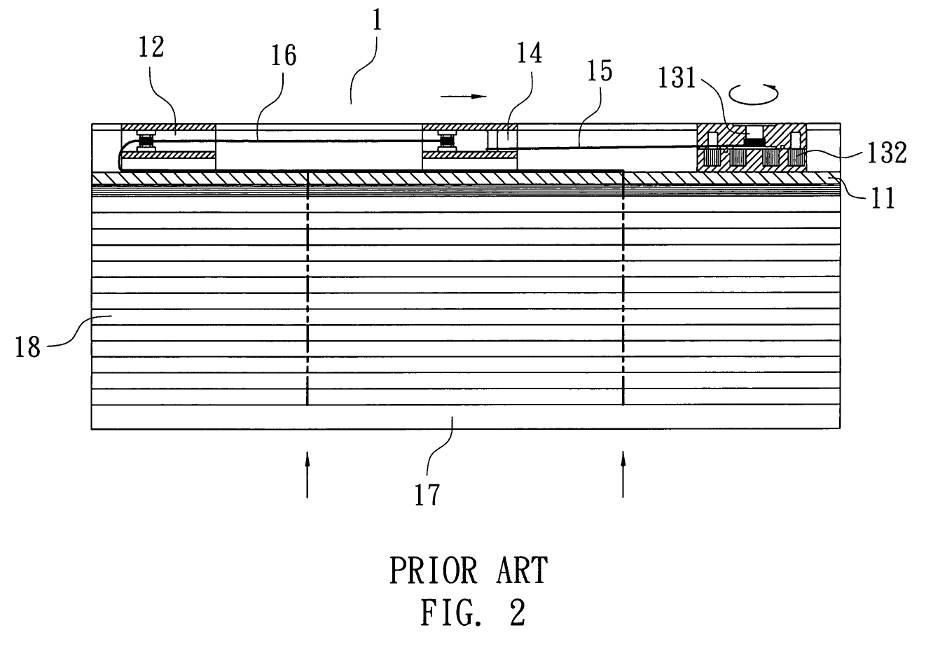

FIG. 3 is a sectional view illustrating detailed structure of the conventional cordless blind.

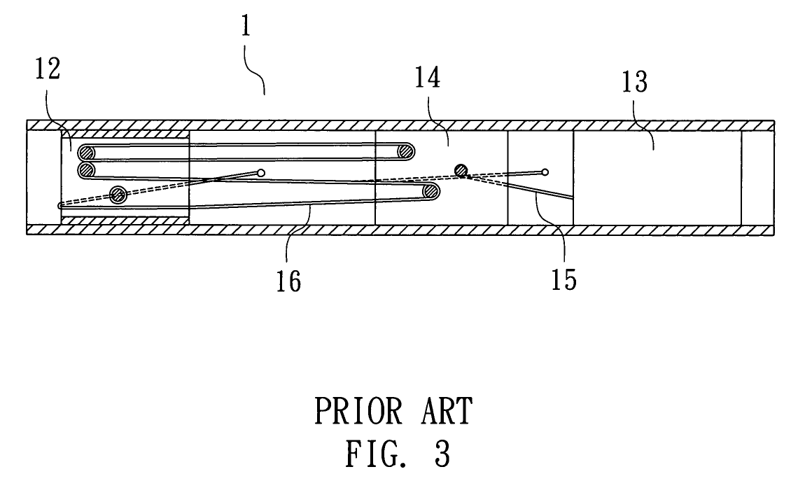

FIG. 4 is a schematic sectional view illustrating use of a folding device in accordance with the present invention with a Venetian blind.

FIG. 5 is a schematic sectional view illustrating use of the folding device in accordance with the present invention with Roman blind.

FIG. 6 is a schematic sectional view illustrating use of the folding device in accordance with the present invention with a pleated blind.

FIG. 7 is a perspective view illustrating the folding device in accordance with the present invention.

FIG. 8 is a sectional view illustrating a portion of the folding device in accordance with the present invention.

FIG. 9 is an exploded perspective view illustrating a portion of the folding device in accordance with the present invention.

### DETAILED DESCRIPTION OF THE PREFERRED EMBODIMENTS

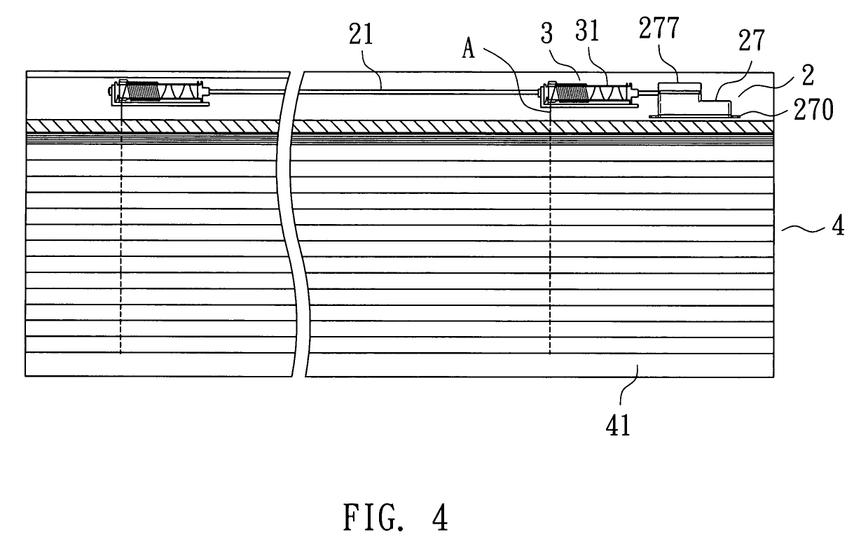

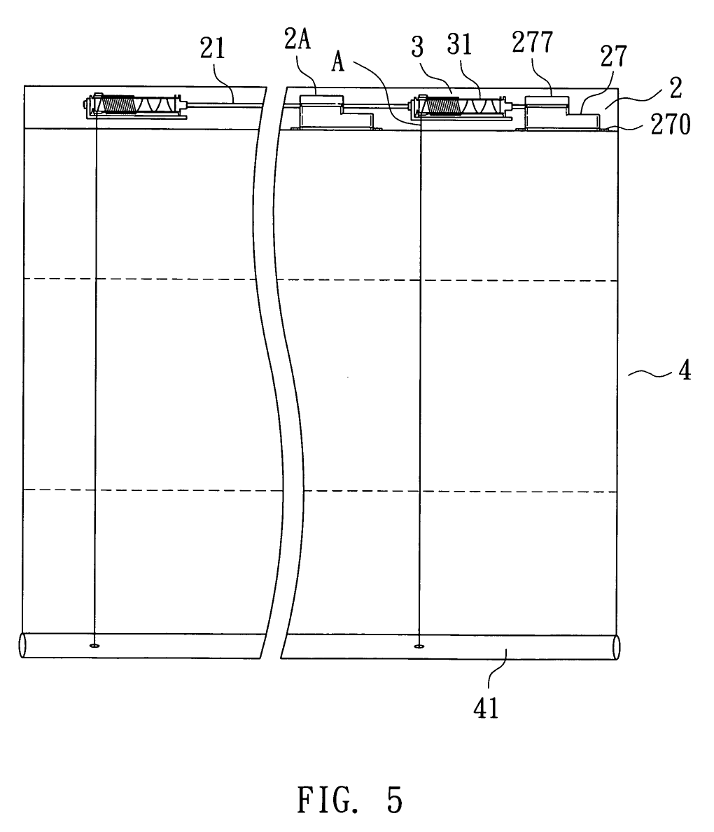

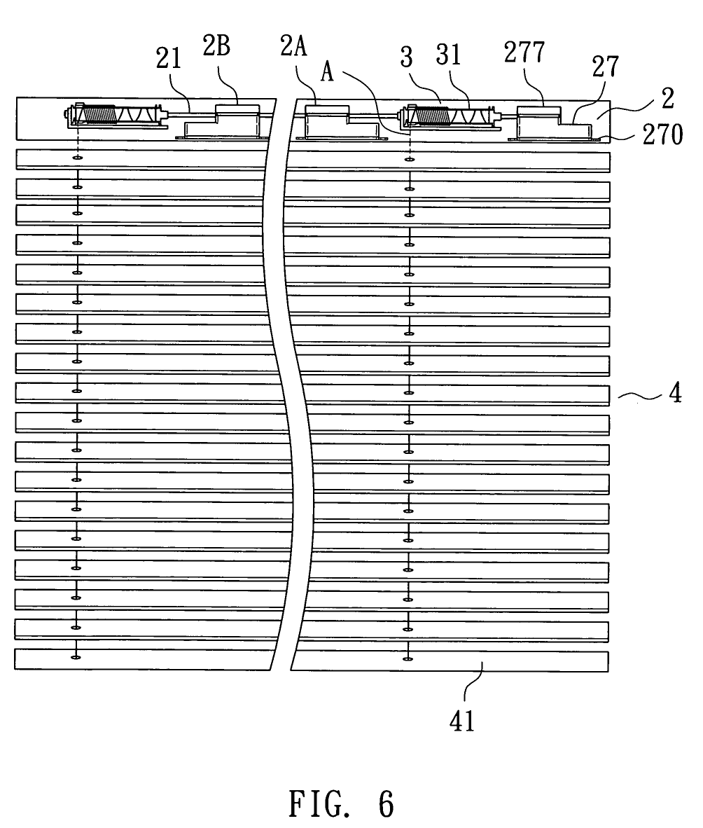

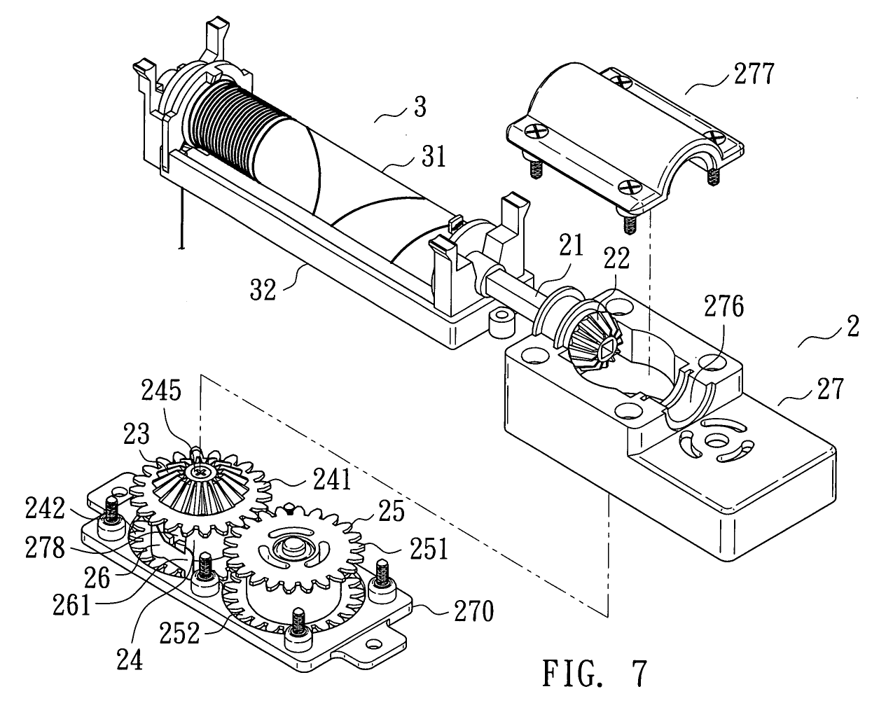

A folding device in accordance with the present invention is illustrated in FIG. 7 and can be used with a Venetian blind (see FIG. 4), a Roman blind (see FIG. 5), a pleated blind (see FIG. 6), or a blind of other type.

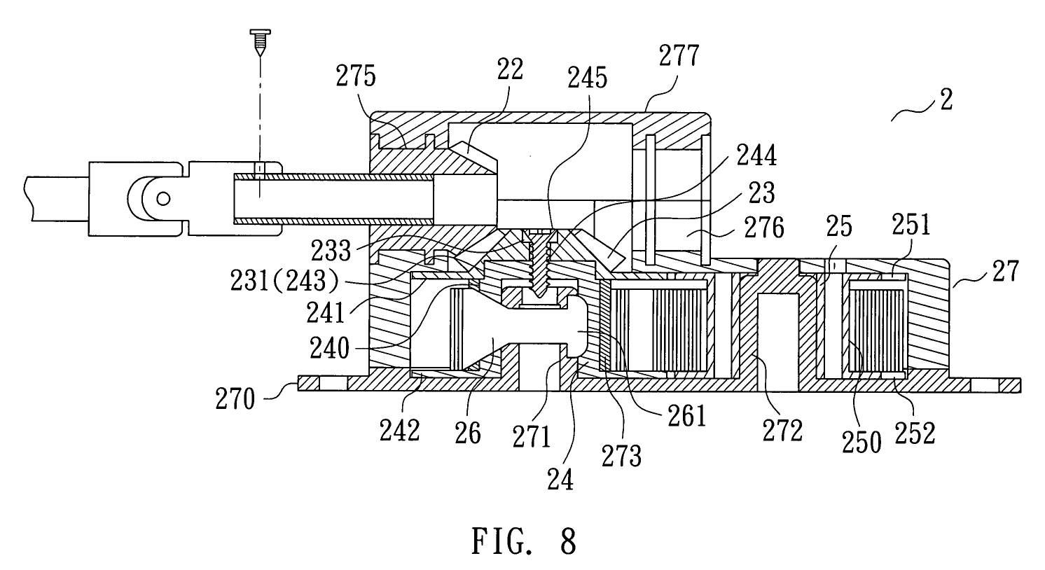

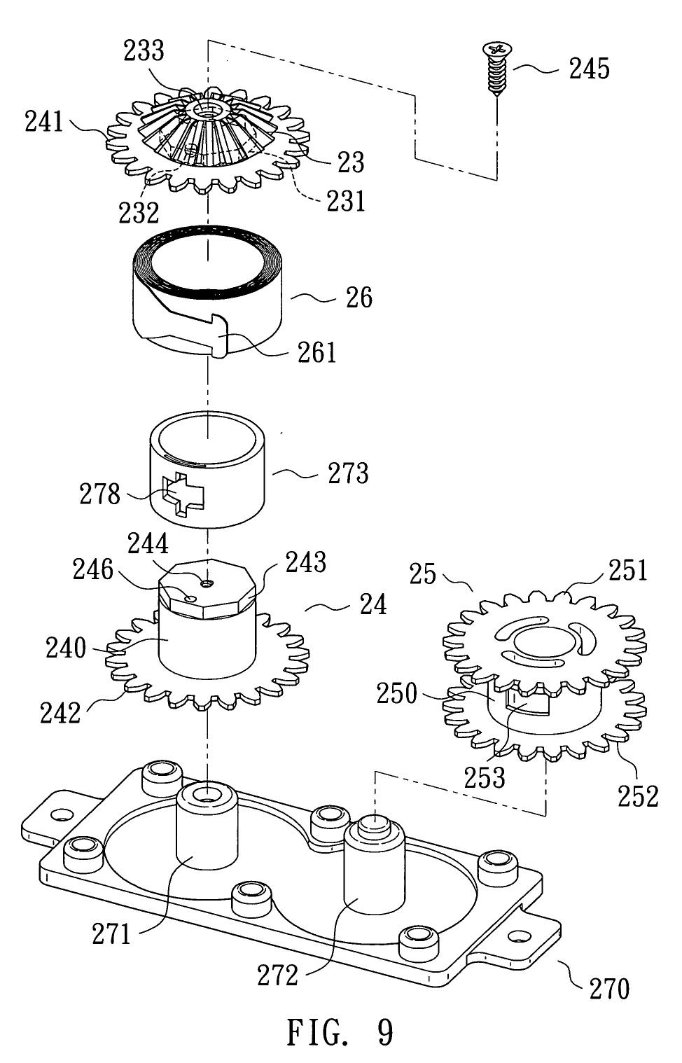

Still referring to FIG. 7 and further to FIGS. 8 and 9, the folding device in accordance with the present invention, comprises a force-return mechanism 2 and a string spool 31 mounted in a spool seat 32 of a string seat mechanism 3. The force-return mechanism 2 includes a transmission shaft 21 extending through or coupling with a shaft of the string spool 31 such that the string spool 31 and the transmission shaft 21 turn jointly.

The force-return mechanism 2 includes a smaller bevel gear 22 connected to the rotating shaft 21. A larger bevel gear 23 meshes with the smaller bevel gear 22 and is rotatable about a vertical axis. Preferably, the gear ratio of the smaller gear member 22 to the larger bevel gear 23 is between 1:2 and 1:5 to provide a better gear ratio and a better reduction ratio. The larger bevel gear 23 is connected to and turns jointly with a first bobbin 24. The larger bevel gear 23 includes a polygonal groove 231 in a bottom thereof, and the first bobbin 24 includes a body 240 having a top end with a polygonal edge for securely engaging with the polygonal groove 231. Furthermore, the larger bevel gear 23 includes a central screw hole 233, and the top end of the body 240 of the first bobbin 24 includes a screw hole 244. A screw 245 is extended through the central screw hole 233 and the screw hole 244 to fix the larger bevel gear 23 and the first bobbin 24 together. To provide reliable positioning during assembly and to provide the assembler with easy identification, the bottom of the larger bevel gear 23 includes a positioning peg 232 whereas the top end of the body 240 of the first bobbin 24 includes a positioning hole 246 for engaging with the positioning peg 232.

The first bobbin 24 and a second bobbin 25 are respectively engaged with two ends of a spiral spring 26 such that winding movement of the spiral spring 26 about a rotating axis of the first bobbin 24 causes unwinding movement of the spiral spring 26 about a rotating axis of the second bobbin 25 and that unwinding movement of the spiral spring 26 about the rotating axis of the first bobbin 24 causes winding movement of the spiral spring 25 about the rotating axis of the second bobbin 25.

By providing a gear reduction between the larger bevel gear 23 and the smaller bevel gear 22, the rotational speed of the spring pool 31 can be relatively high. Nevertheless, the larger bevel gear 23 turns at a relatively low speed such that the spiral spring 26 with a smaller winding/unwinding extent can be used for rotating the string spool 31. Furthermore, the smaller bevel gear 22 provides a retaining effect in the vertical direction, which cooperates with the weight of the blind to provide an optional braking effect for the blind in the vertical direction.

A housing 27 is mounted around the force-return mechanism 2 and, thus, restrains the force-return mechanism 2. A cap 277 is mounted on top of the housing 27 to seal and fix the force-return mechanism 2, thereby completely restraining the force-return mechanism 2. The housing 27 includes a base 270 from which two posts 271 and 272 (see FIGS. 8 and 9) extend upward. The bodies 240 and 250 of the first and second bobbins 24 and 25 are hollow and respectively and rotatably mounted around the posts 271 and 272.

A hollow lining sleeve 273 having an inner diameter greater than an outer diameter of the body 240 of the first bobbin 24 is mounted around the body 240 of the first bobbin 240. An end (not shown) of the spiral spring 26 is extended through a through-hole 278 in a periphery of the hollow lining sleeve 273 and securely fixed to the first bobbin 24. The other end 261 of the spiral spring 26 is extended through a through-hole 253 of the body 250 of the second bobbin. 25. The other end 261 of the spiral spring 26 has a width slightly greater than that width of the through-hole 253 of the second bobbin 25. The other end 261 of the spiral spring 26 is flexible and, thus, can be forcibly inserted through the through-hole 253 of the second bobbin 25 into an inner space of the second bobbin 25. Thus, disengagement of the other end 261 of the spiral spring 26 from the second bobbin 25 is less likely to occur if no external force is applied.

The hollow lining sleeve 273 allows sliding movement to provide a buffering effect for the spiral spring 26 when the first bobbin 24 turns. Optionally, another hollow lining sleeve (not shown) having an inner diameter greater than the outer diameter of the body 250 of the second bobbin 25 can be mounted around the body 250 of the second bobbin 25 to provide a buffering effect for the spiral spring 26 when the second bobbin 25 turns. Specifically, the coils of the spiral spring 26 might kink due to rapid compression or expansion resulting from high winding/unwinding speeds. Provision of the hollow lining sleeve(s) 273 can avoid kink.

The housing 27 further includes a first coupling groove 275 in a side adjacent to the string spool 31. An end of the transmission shaft 21 is supported in the first coupling groove 275, allowing stable rotation of the transmission shaft 21. The housing 27 further includes a second coupling groove 276 in another side opposite to the side having the first coupling groove, 275 such that the transmission shaft 21 can be supported in the second coupling groove 276 when desired. This allows easy, convenient assembly.

A gear 241 is mounted on the upper end of the first bobbin 24 and meshes with a gear 251 mounted on an upper end of the body 250 of the second bobbin 25. In a preferred embodiment, another gear 242 is mounted to a lower end of the body 240 of the first bobbin 24 and meshes with another gear 252 on a lower end of the body 250 of the second bobbin 25. This assists in precise transmission between the first and second bobbins 24 and 25 in addition to movement of the spiral spring 26.

Gears may change the speed or the moving direction. With reference to FIGS. 7 and 8, due to the gear ratio of the larger bevel gear 23 to the smaller bevel gear 22, the larger bevel gear 23 is rotated at a low speed when the string spool 31 turns at a high speed. Thus, the same folding/unfolding effect can be obtained through a small winding/unwinding extent of the spiral spring 26 mounted between the first and second bobbins 24 and 25. Fatigue or deformation is less likely to occur even after the spiral spring 26 is used for a long period of time. Furthermore, the spiral spring 26 can be received in a small space while allowing high speed rotation of the string spool 31 to which an end of string A extending through a shade 41 of a blind 4 is attached. Thus, the spiral spring 26 can be operated in a small winding/unwinding extent while allowing larger travel of the shade 41 of the blind 4 in a vertical direction.

Still referring to FIGS. 6 and 8, when the shade 41 is moved downward for unfolding the blind 4, rotational movement of the string spool 31 causes rotation of the transmission shaft 21, which, in turn, causes rotation of the smaller bevel gear 22 and the larger bevel gear 23. Rotation of the larger bevel gear 23 about a vertical axis causes rotation of the first bobbin 24 and the second bobbin 25 meshed with the first bobbin 24, thereby compressing the spiral spring 26. When the shade 41 of the blind 4. is released, the spiral spring 26 would spring back. Nevertheless, due to the weight of the shade 41 and due to the pressing effect by the smaller bevel gear 22 against the larger bevel gear 23 in the vertical direction, a braking effect is provided. On the other hand, when the shade 41 is lifted and moved upward for folding the blind 4, the force imparted from the weight of the shade 41 to the transmission shaft 21 is reduced such that the vertical restraining force imparted to the larger bevel gear 23 by the smaller bevel gear 22 is reduced. As a result, the spiral spring 26 expands due to its resiliency, urging the smaller bevel gear 22 to turn. Thus, the transmission shaft 21 turns and causes winding of the shade 41. With reference to FIGS. 4 through 6, a plurality of force-return mechanisms 2, 2A, and 2B can be used to provide stronger forces.

Although specific embodiments have been illustrated and described, numerous modifications and variations are still possible without departing from the teachings of the invention. The scope of the invention is limited by the accompanying claims.

What is claimed is:

1. A folding device for a cordless blind, comprising a string spool and a force-return mechanism, the force-return mechanism including a transmission shaft coupled to the string spool to turn therewith, the force-return mechanism further including a smaller bevel gear connected to the transmission shaft, a larger bevel gear meshing with the smaller bevel gear and being rotatable about a vertical axis, a first bobbin being coupled to the larger bevel gear to turn therewith, the force-return mechanism further including a second bobbin and a spiral spring having two ends respectively engaged with the first and second bobbins such that winding movement of the spiral spring about a rotating axis of the first bobbin causes unwinding movement of the spiral spring about a rotating axis of the second bobbin and that unwinding movement of the spiral spring about the rotating axis of the first bobbin causes winding movement of the spiral spring about the rotating axis of the second bobbin, the first bobbin including a top end with a gear, the second bobbin including a top end with a gear meshed with the gear of the first bobbin to assist in transmission between the first and second bobbins, the larger bevel gear and the smaller bevel gear having a gear ratio therebetween to allow high rotating speed of the string spool and low rotating speed of the larger bevel gear such that the string spool is turned with a small winding/unwinding extent of the spiral spring, with the smaller bevel gear pressing against the larger bevel gear in a vertical direction and cooperating with a weight of a shade of a blind to provide an optional braking effect for the shade in a vertical direction.

2. The folding device for a cordless blind as claimed in claim 1 further comprising a housing mounted around the force-return mechanism, the housing including a base, two posts extending upward from the base, each of the first and second bobbins including a hollow body rotatably mounted around an associated one of the posts.

3. The folding device for a cordless as claimed in claim 2 further comprising a hollow lining sleeve mounted around the body of one of the first and second bobbins, the hollow lining sleeve including a through-hole through which an associated one of the ends of the spiral spring extends, the hollow lining sleeve buffering the spiral spring when the one of the first and second bobbins turns.

4. The folding device for a cordless blind as claimed in claim 2 wherein the housing includes a coupling groove in a side thereof adjacent to the string spool, and wherein the transmission shaft is received in the first coupling groove to allow stable rotation of the transmission shaft.

5. The folding device for a cordless blind as claimed in claim 4 wherein the housing further includes a second coupling groove in another side opposite to the side having the first coupling groove.

6. The folding device for a cordless blind as claimed in claim 1 wherein a gear ratio of the smaller bevel gear to the larger bevel gear is between 1:2 and 1:5.

7. The folding device for a cordless blind as claimed in claim 1 wherein the first bobbin further includes a gear mounted to a lower end thereof, and wherein the second bobbin includes a gear mounted to a lower end thereof and meshed with the gear on the lower end of the first bobbin to assist in precise transmission between the first and second bobbins.

8. The folding device for a cordless blind as claimed in claim 2 wherein the larger bevel gear includes a polygonal groove in a bottom thereof, and wherein the body of the first bobbin includes a top end having a polygonal edge engaged in the polygonal groove.

9. The folding device for a cordless blind as claimed in claim 2 wherein the larger bevel gear includes a central screw hole in a bottom thereof, and wherein the body of the first bobbin includes a top end having a screw hole, further including a screw extending through the central screw hole and the screw hole.

10. The folding device for a cordless blind as claimed in claim 2 wherein the larger bevel gear includes a positioning peg in a bottom thereof, and wherein the body of the first bobbin includes a top end having a positioning hole in which the positioning peg is engaged.
